(19) United States
(12) Patent Application Publication
(10) Pub. No.: US 2018/0031059 A1
(43) Pub. Date: Feb. 1, 2018

(54) Brake Pad Waste Collector

(71) Applicant: Joseph Gelb, Moreno Valley, CA (US)

(72) Inventor: Joseph Gelb, Moreno Valley, CA (US)

(21) Appl. No.: 15/223,533

(22) Filed: Jul. 29, 2016

(51) Int. Cl. F16D 65/00

(52) U.S. Cl. CPC F16D 65/0031; F16D 55/225

(57) ABSTRACT

Improvements in collection of brake dust from a disc brake assembly are disclosed. The brake assembly includes a rotor, a caliper, brake pads and a filter. The filter is disposed within a shroud which covers at least 70% of the distal side periphery on both sides of the brake rotor. The housing can encompass the brake caliper so that the amount of brake residue captured and the air flow recycled on the brake rotor can be maximized. The brake dust waste collector can incorporate one or more magnets within the air stream to collect heavy particles smaller than 40 nm that can fall from gravity or vibration. The filters collect particles larger than 40 nm as the air is forced through the housings. The air is forced out of the impeller housing and onto the rotor to aid in cooling of the braking system.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a disc brake assembly. More particularly a disk brake assembly that collects friction material waste particle discharge from brake pads in disc brake assemblies.

### Description of Related Art Including Information Disclosed Under 37 CFR 1.97 and 1.98

Currently there are over 1.25 billion units on the road (0.32 billion in the USA), a minimum of 5 billion brakes or 10 billion pads. In addition, the industry manufactures around 90 million units per year which represents around 1 billion brake pads. All these deposit debris to the surroundings.

Dust was initially a “dirt” issue but the environmental and health concerns resulted in “Sustainable Conservation” bringing together interested stakeholders under the banner “Brake Pad Partnership”. This concluded that some 50% of brake dust becomes airborne, about 12% falls to the road and 38% sticks to the car. The Partnership estimated that in 2010 some 580 tons of copper found its way into the California waterways and recommended “source control” rather than water treatment. This led to the signing of Senate Bill (SB) 346 [3] in 2010 that limits copper in pads to 0.5% by 2025—now enforced in the State of California and Washington State.

The airborne particles, less than 10 μm (PM10)—the 50% proportion of generated brake dust—are a principal health issue as these are inhaled and lodge in the lungs.

A European Environment Agency research project estimates that brake wear will contribute up to 55% of non-exhaust air pollution from vehicles. Most serious is that some USA and EC research concludes “the identified compounds are known to have adverse effects even with mutagenic and carcinogenic potency to humans”.

Dust will always be generated with friction brakes regardless of formulation. The very expensive process of modifying brake pad formulation when problems are identified is not a sensible way forward.

Disc brake systems are the most common form of braking mechanisms used today for vehicle wheels and most specifically for mass produced motorcycles and automobiles. Disc braking systems work by utilizing brake pads which are compressed against a rotor (also called a disc) to slow down a vehicle's wheels. As a by-product of this system, a large amount of heat is released as the kinetic energy from the wheel momentum is converted by the friction created by the brake pads. Additionally, as brake pads erode, they release harmful particles into the atmosphere. These harmful particles can also enter and pollute water streams. The present invention addresses and alleviates these common problems.

No viable or cost effective on-vehicle dust collection system exists on the market. Some proposals make use of vacuum technology but this cannot ensure complete dust collection in both a forward and reverse direction, nor is it feasible to adapt to 2wheelers. Such systems are costly, absorb power and the moving parts add to reliability concerns.

Brake dust contributes equally to environmental pollution as exhaust emissions. The concerns towards the effects on humans has triggered significant research which shows that during heavy braking new materials are formed, some being cacogenic and mutagenic. Also particle sizes less than 2.5 nm are released to the atmosphere, these penetrating deep into the lungs. Until now no “on-vehicle” system exists that allows the dust to be collected at source. The developing technique embraces the whole of the brake. The module allows clean air to enter, scrubs the brake disc, filters the air and allows clear air back to the environment. A number of patents and or publications have been made to address these issues. Exemplary examples of patents and or publication that try to address this/these problem(s) are identified and discussed below.

The waste particles that are released into the atmosphere from brake pads also create multiple dilemmas. As force is applied to brake pads, the material on the pads is ground away. This material is known as brake dust and can be problematic for two main reasons. The first is that brake dust is highly corrosive and harmful to the environment. It is estimated that up to ninety percent of the worn away brake pad particles are released into the atmosphere. The dust particles created, which contains copper, brass, Kevlar, carbon fibers, metal filings to name a few and acidic adhesive material, is extremely caustic to the environment. The second problem is that the remainder of the brake dust particles that are not released into the atmosphere is deposited on the vehicle wheels. The brake dust particles can be corrosive enough to burn through wheel coatings and leave expensive wheels damaged and unsightly. As a result, there have been a number of devices that have introduced dust shields or filter systems designed to reduce brake dust. These include U.S. Pat. Nos. 7,094,268, 4,484,667, 6,371,569, 6,173,821, 6,932,199, 6,155,650 and 5,772,286. U.S. Pat. No. 5,162,053 discloses a system that utilizes a suction mechanism along with a filter to capture brake dust. Finally, U.S. Pat. No. 6,592,642 discloses a device that utilizes an electrostatic charge to collect charged brake dust particles.

The inventor also has prior U.S. Pat. Nos. 8,191,691 and 7,963,376 that describe a system for collecting brake dust, but these patent fail to describe the collection of small metallic particles from being released into the environment.

None of the above-referenced devices addresses all the problems associated with brake pad waste. Therefore, there is a need for a system that can provide additional cooling air to brake rotors, prevent harmful brake dust particles from being discharged into the atmosphere, and protect the finish on vehicle wheels from being damaged. Accordingly, the present invention described herein encompasses these and other elements.

What is needed is a brake dust collecting device as the world's first practical disc brake friction material wear debris collection system. The Clean Brake Performance Module or CBPModule will be a competitively priced, lightweight module, providing improved braking performance and a cleaner global environment.

### BRIEF SUMMARY OF THE INVENTION

It is an object of brake dust waste collector to provide a housing that fits around a brake disc which holds the impellers, drive shaft, and filters. In an alternative embodiment, twin impellers could be used on either side of the rotor to maximize the air flow through the impellers.

It is another object of the brake dust waste collector to provide an impeller housing that has an inlet to allow air to enter the shrouding. There is a mesh filter on the inlet which can capture particles as air is forced into the impeller housing.

It is another object of the brake dust waste collector to provide another filter on the impeller housing outlet to capture the remaining particles as air is forced out of the impeller housing and onto the rotor to aid in cooling of the braking system.

In another exemplary embodiment of the brake dust waste collector, the housing can be designed to encompass the brake caliper so that the amount of brake residue captured and the air flow recycled on the brake rotor can be maximized.

It is another object of the brake dust waste collector to provide pressure release valves near the air intake and outlet on the impeller housing. When either of these valves is activated, it will allow air to bypass the filters in the case they have been clogged. The bypassed air will be redirected to the brake rotor to aid in cooling.

It is still another object of the brake dust waste collector to incorporate one or more magnets that collect heavy particles that can fall from gravity or vibration.

It is an object of the brake dust waste collector or Clean Brake Performance Module (CBPM) to totally enclose the brake ensuring dust is collected whenever the vehicle is in motion and when the brake is used.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a sectional perspective view of a brake dust waste collector.

FIG. 2 shows an exploded inner pad side view of the brake dust waste collector.

FIG. 3 shows an exploded outer pad side view of the brake dust waste collector.

FIG. 4 shows a plan assembled view of the brake dust waste collector.

FIG. 5 shows sectional view of the brake dust waste collector taken from section line 5-5 from view 4.

FIG. 6 shows a perspective sectional view of the brake dust waste collector.

FIG. 7 shows a picture of the ferric metal dust collected on multiple magnets of the brake dust waste collector.

FIG. 8 shows a detailed picture of the ferric metal dust collected on a magnet of the brake dust waste collector.

### DETAILED DESCRIPTION OF THE INVENTION

A feature of the design is that the caliper is still visible so vehicle manufacturers that wish to use their view are still maintained. In addition, the outer surface of the casing may be personalized to emphasize the character of the vehicle. As such the outer casing may be constructed of carbon fiber, glass fiber, brushed stainless steel or anodized aluminum alloy. A further feature is that it is possible to develop the design so that the clean airflow gap between the two module halves may be automatically adjusted individually to suit operating conditions.

The added advantage of a totally enclosed brake is that it reduces the effects of NVH as it inherently acts as a noise barrier but insulation may be also included in the design. The temperature reductions minimize the potential for judder and brake fade.

The market is in direct line with new and existing vehicles that includes cars, commercial trucks & trailers, rail and 2-wheelers.

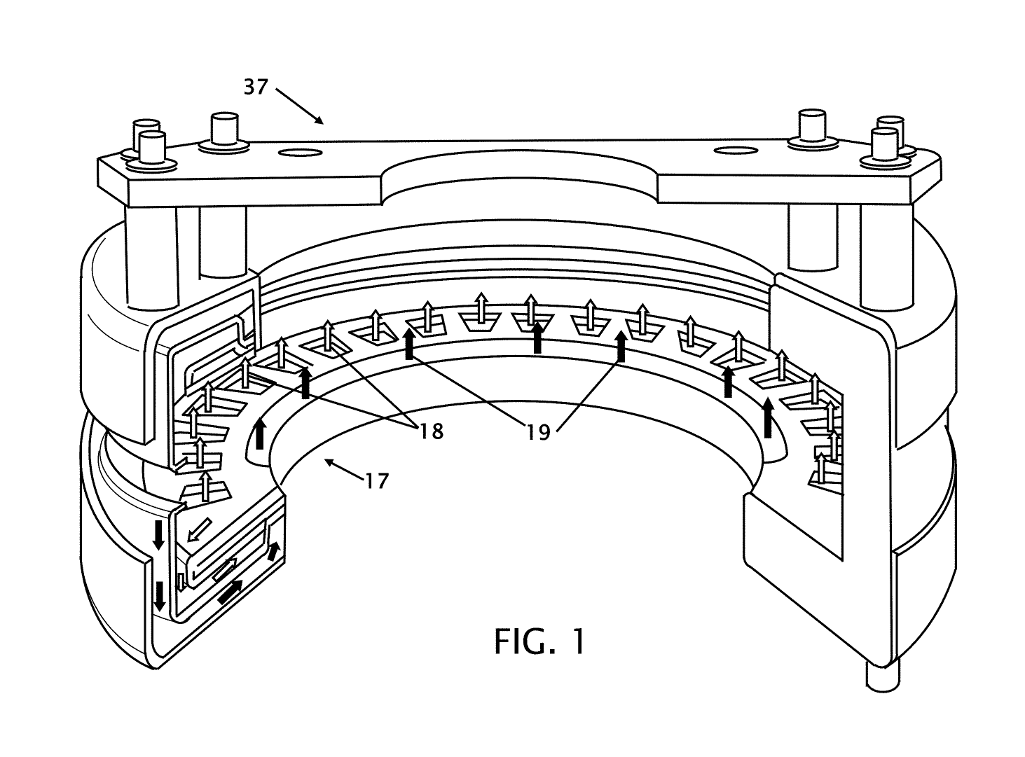

FIG. 1 shows a sectional perspective view of a brake dust waste collector. From this view, a portion of the disc brake caliber 37 and housing 17 is visible with a portion of the Clean Brake Performance Module or CBPModule visible with the vented rotor. The rotor has been removed for clarity, but the outer collection portions are visible and shows how the contaminated air 19 (black arrows) flow from the brake pads and rotor through the filtering system to return filtered air 18 (white arrows) into the system.

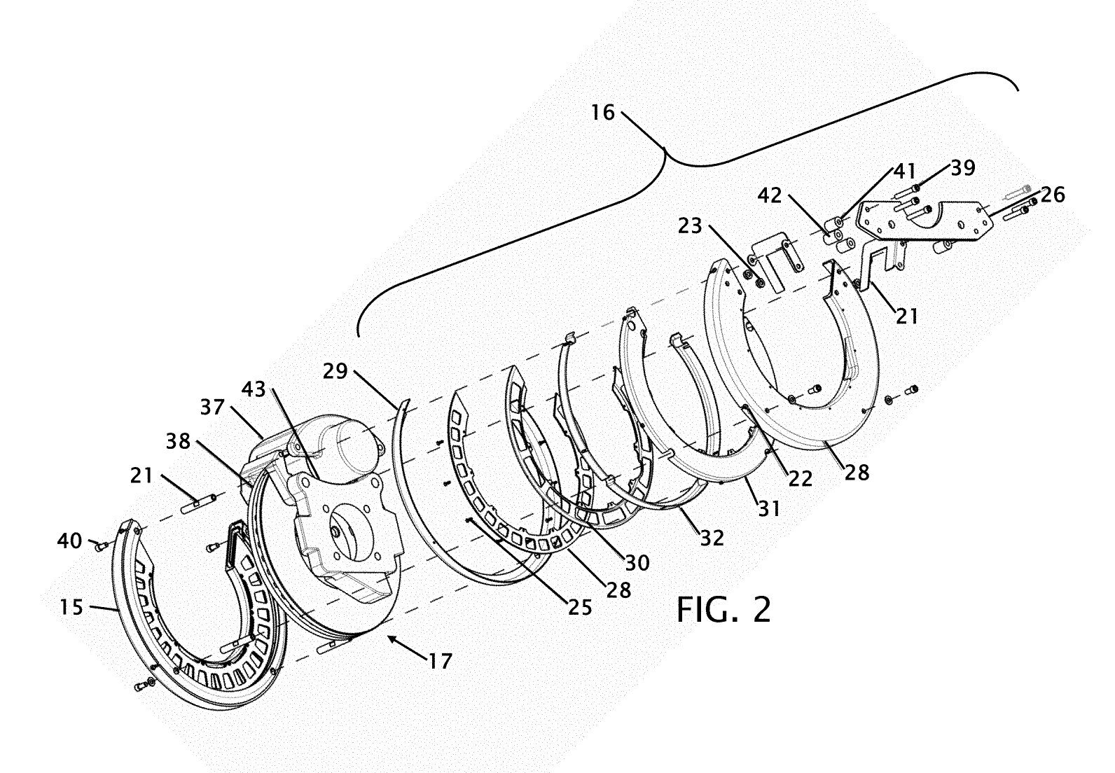

FIG. 2 shows an exploded inner pad side view of the brake dust waste collector. This exploded view shows the assembly of the Clean Brake Performance Module or CBPModule inner module. The assembly includes the end cap A 33, C ring sector 30, E ring sector 32 and the D ring sector 31. These components are secured between B ring sector 29 and A ring sector inner 28 with fasteners 22 and 25. The version 2 is held with fasteners 39 through spacers 42 and a mount 26 with nuts 23. A bracket 24 maintains a fit with the strut mount 43 and caliber 37. The rotor 38 and rotor assembly 17 is held on one side and the inner module 15 is held on the other side of the rotor 17. A rod 27 and fastener 40 allows the modules to move with the caliber as the brake pads and rotor 38 wears.

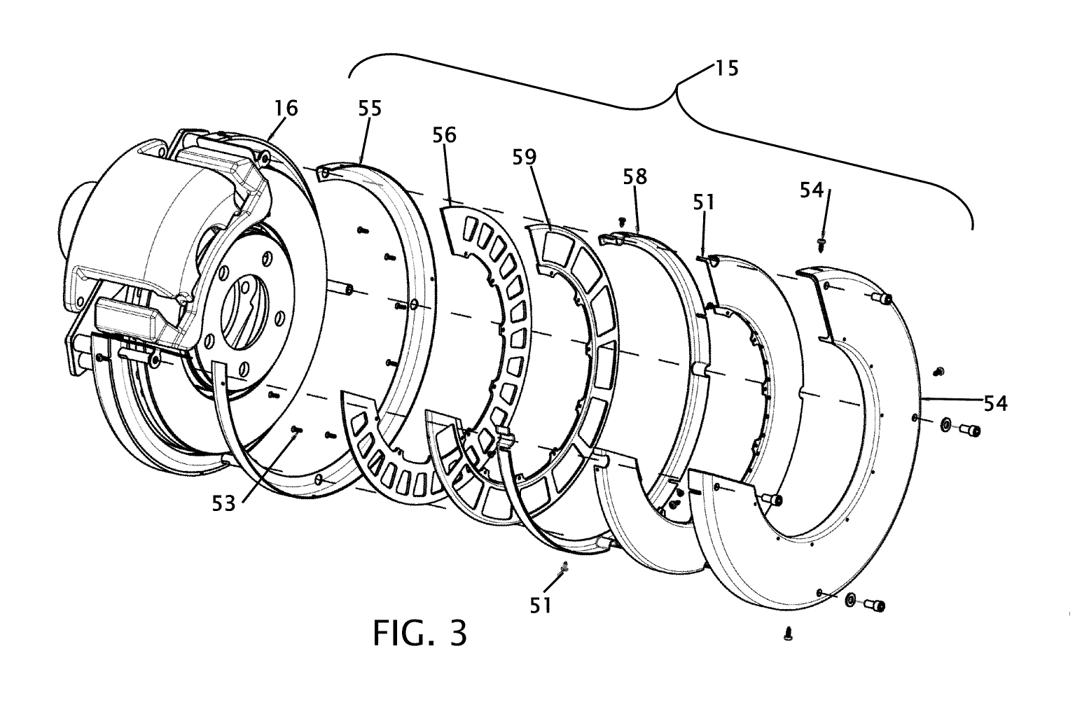

FIG. 3 shows an exploded outer pad side view of the brake dust waste collector. This assembly of the inner 15 Clean Brake Performance Module or CBPModule inner module. A portion of the outer module 16 is visible on the other side of the brake housing and caliber. This assembly shows the C ring sector 56, F ring sector outer 59 and the E ring sector secured with fasteners 51 and 53. These components are secured between the B ring sector 55 and the D ring sector 57, with the A ring sector outer 54 covering the assembly with fasteners 52.

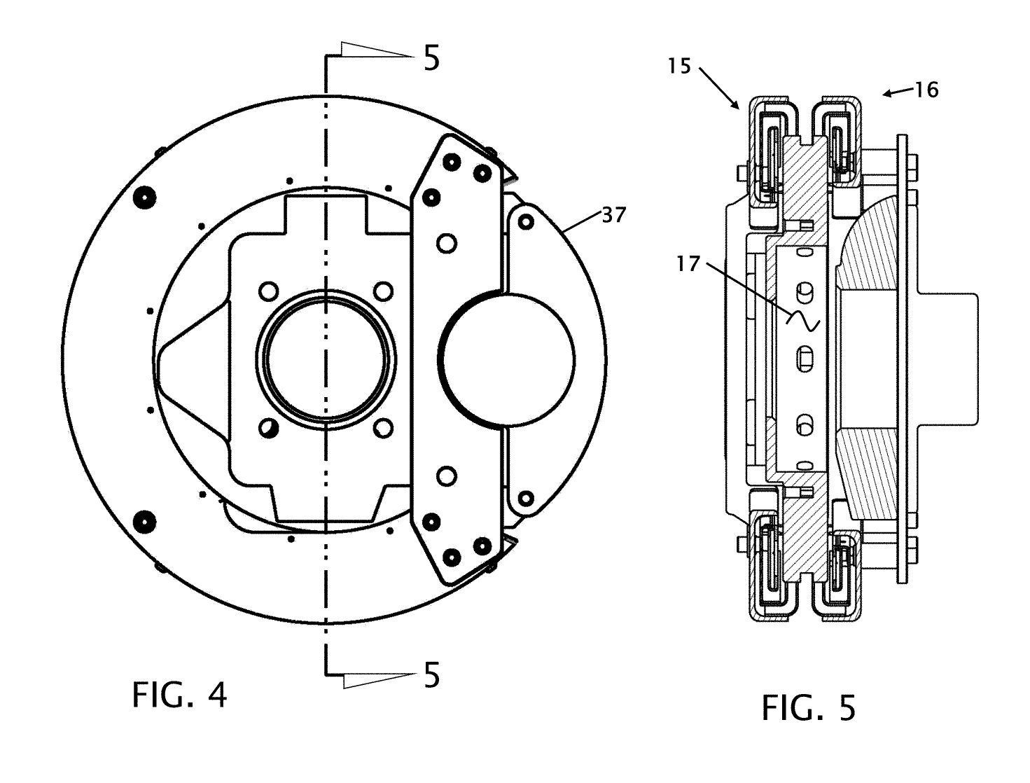

FIG. 4 shows a plan assembled view of the brake dust waste collector and FIG. 5 shows sectional view of the brake dust waste collector taken from section line 5-5 from view 4. These views show the disc brake caliber 37 with the rotor 17. The outer CBPModule 15 is shown on one side of the rotor 17, and the inner CBPModule 16 is shown on the other side of the rotor 17.

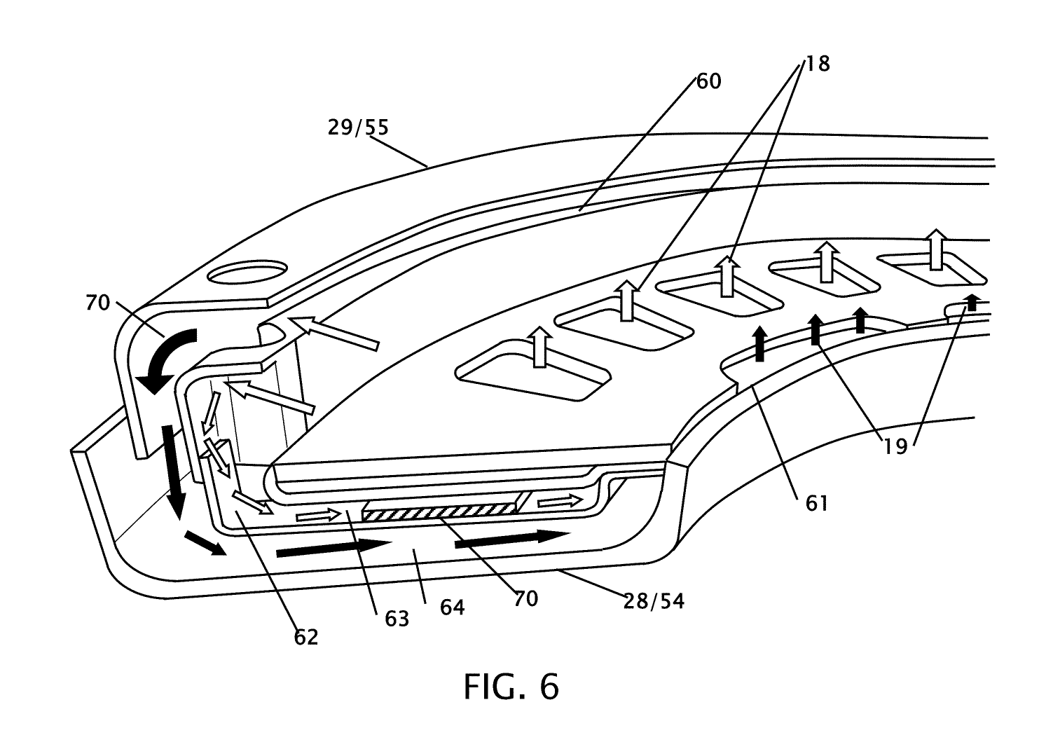

FIG. 6 shows a perspective sectional view of the brake dust waste collector. Clean air 18 (shown as white arrows) flows in at the bottom of the disc and flows radially outwards through the vents. At the outer edge of the disc the module employs two lipped members 60 to “tap-off” an amount of the vent airflow. This portion of airflow is dictated by the degree of lip overhang into the vent outlet area and is directed into a bypass channel 62 formed by the module outer casing to an outer high pressure region. The air then flows downwards to a low pressure region and back towards the disc surface 63 and then driven outwards to the outer rim of the disc. At this point a second lip 61 guides the total airflow into a filter channel forcing it through the filters 18 and back towards the disc surface where it “scrubs” the disc surface of dust. The air is thus constantly recycled and filtered. Once the recycling process has been established (whenever the wheel is rotating) the majority of air will pass through the disc vent so maximizing cooling. This loop of air movement is maintained between the inner ring sectors 29/55 and the outer ring sectors 28/54 to maintain and direct air movement and dust collection within the filtering system.

The first build module collected a minimum of 92% of brake debris. A second improved design is to be tested when it is expected this value will increase. Dimensional wear reduction of the pads is average 25%, and disc 58% so extending component life. It has no detrimental effect on brake temperature and in the majority of tests it reduces temperatures thus reducing events of judder and brake fade. It has no effect on brake performance. There are no moving parts. The modules can include magnets 70 that collect spent rotor material or other metallic debris. The filters are reusable and changed during normal servicing routines. There is a positive reduction of NVH issues.

The module potentially satisfies the Senate Bill, “SB-346 Hazardous materials: motor vehicle brake friction materials SEC. 2” exemption rule which states: “25250.55. Brake friction materials for the following motor vehicle classes are exempt from this article: (b) Vehicles employing internal closed oil immersed brakes, or a similar brake system that is fully contained and emits no copper, other debris, or fluids under normal operating conditions”.

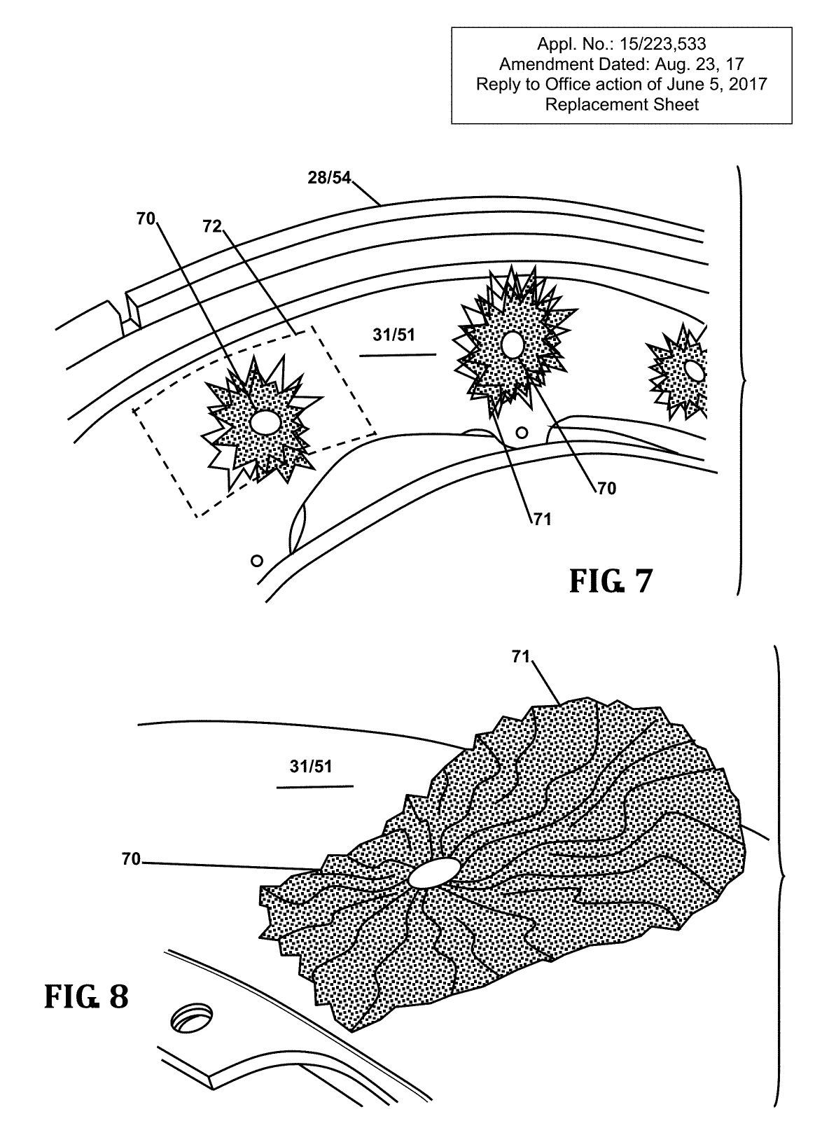

FIG. 7 shows a picture of the ferric metal dust collected on multiple magnets of the brake dust waste collector and FIG. 8 shows a detailed picture of the ferric metal dust collected on a magnet of the brake dust waste collector. The magnets 70 are held or secured on the inner D ring sector 31/outer D ring sector 51. In FIG. 7, the inner A ring sector 28/outer A ring sector 54 is shown around the D ring sector(s). The magnets 70 collect steel debris 71 as it flows with the air being moved.

The airflow behind the filter cage includes magnets 70 that are capable of withstanding 120 degrees of temperature. The next module is impregnated with magnets 70 inside of the filter as well as behind the cage to aid in the collection of debris. The debris collected by the magnets 70 can be removed by vacuuming the magnets with a force stronger than the magnetic force, by placing the module in a plastic bag, then using an electromagnetic degaussing plate to pull the debris into a bag, by heating the magnets up beyond the rated temperature. The debris will then fall off, basically losing all of the magnetic properties. It is also contemplated that the magnets 70 can be covered with Kapton or similar tape that can be removed to lift the debris away from the magnetic field.

Thus, specific embodiments of a brake dust waste collector have been disclosed. It should be apparent, however, to those skilled in the art that many more modifications besides those described are possible without departing from the inventive concepts herein. The inventive subject matter, therefore, is not to be restricted except in the spirit of the appended claims.

1. A brake dust waste collector comprising:
a rotor that is turned by motion of a vehicle;
a caliper and brake pads attached to the caliper;
the rotor having an inside face periphery, an outside face periphery and an outside diameter periphery;
at least one filter disposed within ring sectors;
the ring sectors having opposite side walls, opposed ring sectors end openings and ring sector interiors;
the ring sectors being disposed proximate to the rotor so as to cover an area not occupied by said caliper, and
each ring sector houses a filter consisting of a axial inner filter in an inner ring sector and a axial outer filter in an outer ring sector, and wherein when said vehicle is in motion, a rotational turning of said rotor is a predominant driving force that moves air, filtered air and brake dust into said axial inner filter and said axial outer filter within said ring sectors.

2. The brake dust waste collector according to claim 1 wherein each ring sector is disposed proximate to the rotor, on opposite sides of the rotor, such that the two ring sectors cover area of a rotor not being covered by said brake pads.

3. (canceled)

4. The brake dust waste collector according to claim 1 wherein the ring sectors cover at least about 70% of the distal edge periphery wherein one of the ring sector side walls defines an opening with an airflow gap disposed in fluid communication therewith to direct air flowing out of the ring sector to the rotor.

5. The brake dust waste collector according to claim 1 wherein the ring sectors defines a pair of separate airflows disposed on opposite sides of the rotor.

6. The brake dust waste collector according to claim 1 covers at least some of said caliper or at least some of said brake pads.

7. The brake dust waste collector according to claim 1 wherein said at least one filter is replaceable, changeable or cleanable.

8. The brake dust waste collector according to claim 1 wherein said ring sectors further include at least one magnet.

9. The brake dust waste collector according to claim 1 wherein each said ring sectors includes a lipped member located in proximity to the outer radius of the rotor redirects air filtered by said at least one filter to recirculate at least some filtered air towards said rotor.

10. (canceled)

11. The brake dust waste collector according to claim 9 wherein said airflow carries both heat and waste particles away from the brake pads.

12. A brake dust waste collector configured to operate with a disc brake comprising:
a pair of filters disposed within opposing ring sectors;
the ring sectors having opposite side walls, opposed ring sectors end openings and a shroud interior;
the ring sector being disposed proximate sized a rotor so as to cover an area not occupied by a brake caliper of said rotor, and
said ring sectors house filters consisting of an inner filter and an outer filter, and wherein when said rotor turns, rotation of said rotor moves brake dust into said inner filter and said outer filter and recirculates at least some filtered air back towards said rotor.

13. The brake dust waste collector according to claim 12 wherein said inner filter is disposed between two module halves.

14. The brake dust waste collector according to claim 12 wherein said inner filter is disposed between two ring sectors.

15. The brake dust waste collector according to claim 12 wherein said at least one filter further includes at least one magnet that collects particles.

16. The brake dust waste collector according to claim 12 wherein each ring sector includes an inner ring sector and an outer ring sector disposed in proximity to each side of said rotor.

17. The brake dust waste collector according to claim 12 wherein said disk brake is on a vehicle.

18. (canceled)

19. The brake dust waste collector according to claim 12 provides cooling to said disc brake.

20. The brake dust waste collector according to claim 12 wherein said ring sectors includes at least one lipped member located in proximity to the outer radius of the rotor that redirects air flow into said ring sectors.

21. The brake dust waste collector according to claim 12 wherein each of said ring sectors includes a bypass channel formed in an outer casing of each of said ring sectors whereby at least some air that passes through said pair of filters is returned towards an axial surface of said rotor.

22. The brake dust waste collector according to claim 9 wherein each of said ring sectors includes a bypass channel formed in an outer casing of each of said ring sectors.

23. The brake dust waste collector according to claim 22 wherein said bypass returns at least some cleaned that is not replaced by unfiltered air from said rotor.
